(19) United States
(12) Patent Application Publication
(10) Pub. No.: US 2012/0317145 A1
(43) Pub. Date: Dec. 13, 2012

(54) METHOD AND APPARATUS FOR FILE ASSURANCE

(76) Inventors: Joseph P. Reghetti, Reno, NV (US); Anthony M. Conte, Reno, NV (US)

(21) Appl. No.: 13/492,689

(22) Filed: Jun. 8, 2012

Related U.S. Application Data
(60) Provisional application No. 61/495,887, filed on Jun. 10, 2011.

(51) Int. Cl. G06F 17/30

(52) U.S. Cl. 707/781; 707/E17.005

(57) ABSTRACT

A system and associated processes for file assurance. A user may use the system to maintain control over a file that is distributed to another user. The user may specify a number of file access options, such as read-only, report distribution, or track edits. The system may encrypt the file with the file access options included. The file may be altered so as to make the file no longer readable by an application designed to read the file without the system, or a corresponding system associated with the recipient user. The system or corresponding system may enforce the file access options selected by the user. Further, in some embodiments, the system may report the occurrence of file access or the performance of specific operations on the file to the user.

### CROSS REFERENCE TO RELATED APPLICATIONS

This application claims benefit under 35 U.S. §119(e) of Provisional U.S. Patent application No. 61/495,887, filed Jun. 10, 2011, the contents of which is incorporated herein by reference in its entirety.

### TECHNICAL FIELD

This application relates to the field of document access security systems and document rights management and more particularly to a system and method for securing a file, tracking access to the secured file, and controlling the secured file.

### BACKGROUND

A number of situations exist where a user may desire to share access to a file with another user, but maintain a level of control over the contents of the file. For example, a designer may want to provide to a manufacturer view and print access to a drawing file to enable the manufacturer to comment on the design and to produce a product based on the design. However, the designer may want assurance that the manufacturer does not share the file without the designer's knowledge, or does not inadvertently, or maliciously, edit the file causing a design defect. As a second example, a user may want assurance that a recipient does not edit a legal document, in whole or in part, or that all edits are marked for the user's review.

### SUMMARY

One embodiment provides a system and associated processes for file assurance. A user may use the system to maintain control over a file that is distributed to another user. The user may specify a number of file access options, such as read-only, report distribution, or track edits. The system may encrypt the file with the file access options included. The file may be altered so as to make the file no longer readable by an application designed to read the file without the system, or a corresponding system associated with the recipient user. The system or corresponding system may enforce the file access options selected by the user. Further, in some embodiments, the system may report the occurrence of file access or the performance of specific operations on the file to the user.

### BRIEF DESCRIPTION OF THE DRAWINGS

Throughout the drawings, reference numbers are re-used to indicate correspondence between referenced elements. The drawings are provided to illustrate embodiments of the inventive subject matter described herein and not to limit the scope thereof

FIG. 1 illustrates an embodiment of a file distribution environment in accordance with the teachings of the present disclosure.

FIG. 1A illustrates an embodiment of a user interface facilitating distribution user selection of security, tracking and distribution options for one or more files to be secured.

FIG. 2 illustrates a flow diagram for an embodiment of a secure file creation process.

FIG. 3 illustrates a flow diagram for an embodiment of a process for rendering a native file inaccessible by a corresponding application.

FIG. 4 illustrates a flow diagram for an embodiment of a secure file access process.

### DETAILED DESCRIPTION OF ILLUSTRATIVE EMBODIMENTS

A file assurance system and associated processes is disclosed herein that may enable a user to maintain control over a file that is distributed to one or more other users. The distributing user may specify a number of file access options to the system, such as read-only, report distribution, or track edits. The system may encrypt the file with the file access options included. Once encrypted, the file may no longer be accessed by the application that created the file without the system, or a corresponding system associated with the recipient user, decrypting the file. The system or corresponding system may enforce the file access options selected by the user. Further, in some embodiments, the system may report the occurrence of file access or the performance of specific operations on the file to the user.

### Example of a File Distribution Environment

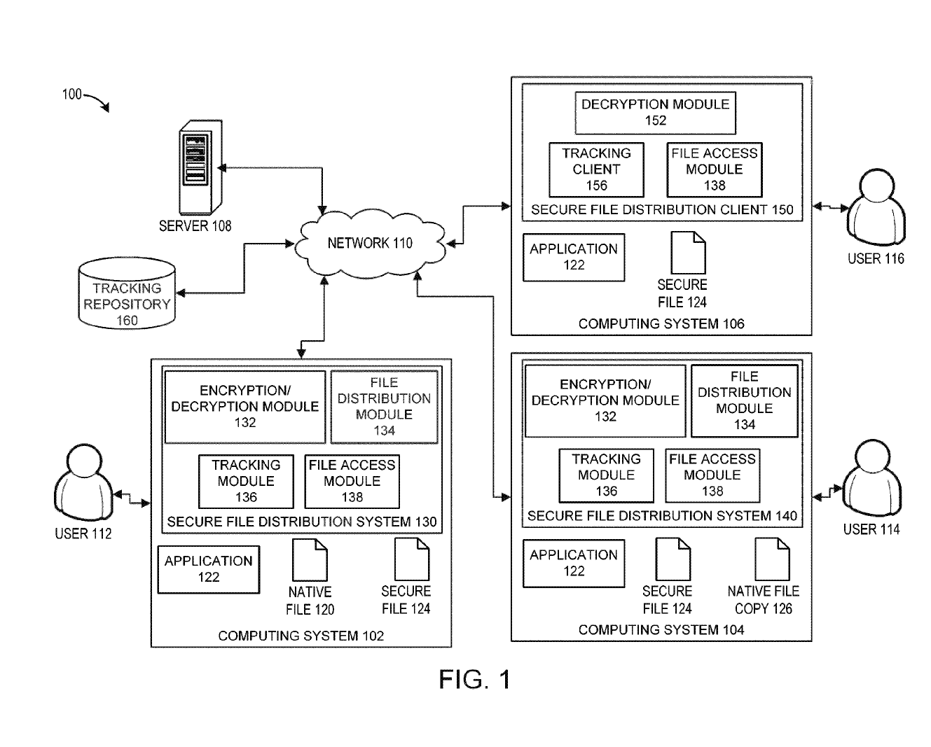

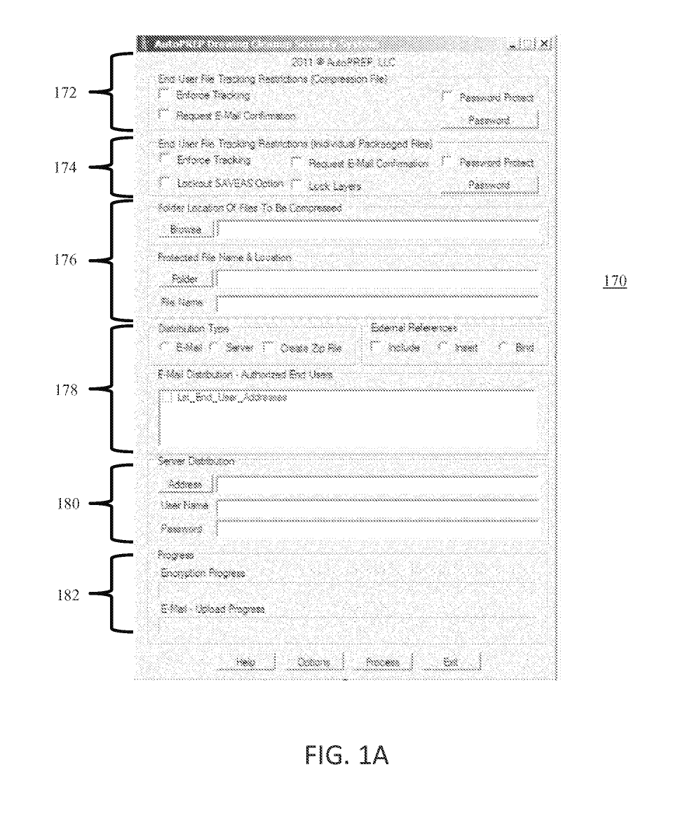

FIG. 1 illustrates an embodiment of a file distribution environment 100 in accordance with the teachings of the present disclosure. In the illustrated embodiment, a user 112 may distribute a native file 120 to, for example, a user 114 using a secure file distribution system 130. The native file 120 may represent any type of file created by an application 122 or that may be accessed by the application 122, such as a text document, pictures, a spreadsheet, a drawing file, legal documents, audio files, video files, etc. Further, the application 122 may represent any type of application that may run on a computing system, such as a computing system 102. For example, the application 122 may represent a computer-aided design (CAD) or drafting application, a word-processing application, an operating system, or an audio or video processing application, to name a few.

Generally, the secure file distribution system 130 may represent any distribution system that may enforce a set of user preferences with respect to the native file 120 (or a copy of the native file 120) when distributed to a computing system, such as computing system 104. The computing system 104 may or may not be associated with the same organization that created the native file 120 or provided the native file 120 to the computing system 104. Further, the computing system 104, as well as the computing systems 102 and 106, may generally include any computing device(s), such as desktops, laptops, and wireless mobile devices (e.g. Smart phones, PDAs, tablets, or the like), to name a few. In one embodiment, the computing systems may also include video game platforms, television set-top boxes, televisions (e.g., internet TVs), and computerized appliances that may be capable of creating and/or distributing a file, to name a few. In one embodiment, the computing systems may include any computing device that may communicate with another computing device via a network 110. The network 110 may include any type of wired or wireless network. For example, the network 110 may include a LAN, WAN, corporate intra net, or the Internet, to name a few.

The secure file distribution system 130 may be an application-specific hardware module that is included with the computing system 102. Alternatively, the secure file distribution system 130 may be a stand-alone hardware system that may be configured to communicate with the computing system 102 via, for example, a Universal Serial Bus (USB) port or the network 110. In some embodiments, the secure file distribution system 130 may be a software application. Alternatively, the secure file distribution system 130 may be a combination of hardware and software. Further, although depicted as running on the computing system 102, the secure file distribution system 130 may also be hosted on a server, such as the server 108, or any other computing system and need not be part of computing system 102, 104 or 106.

To facilitate enforcing a set of user preferences with respect to the distribution of the native file 120, the secure file distribution system 130 may create a secure file 124 from the native file 120, basically a copy of the native file 120, but without opening or otherwise accessing the native file 120 except to make the copy included in the secure file, thereby maintaining the integrity and security of the native file 120. The secure file 124 may then be provided to the computing system 104 associated with the user 114. This secure file 124 may also include the set of user preferences, and any additional information required to implement the user preferences (e.g. The user's 112 email address if one of the preferences includes notification of file access), some or all of which may be encrypted.

In an embodiment, a native file may be modified so as to make the modified version of the native file unreadable by any application that can read the native file. A composite file may then be created based on a combination of the modified native file and additional information based on distribution user option selections associated with access restrictions and tracking The modified native file may then be compressed prior to creation of the composite file or the composite file may be compressed, or neither file may be compressed. The resulting file, whether compressed in some form or not, may then be encrypted. As referenced herein, a “secure file” refers to a composite file, a compressed native file, a compressed composite file, or an encrypted file.

In one embodiment, the secure file distribution system 130 may include a number of modules that may be implemented in hardware, software, or a combination of the two. In the depicted embodiment of FIG. 1, the secure file distribution system 130 may include an encryption/decryption module 132, a file distribution module 134, a tracking module 136, and a file access module 138. Other operations of secure file distribution system 130, 140 and/or 150, as represented by FIG. 1, may be separated into additional separate modules, such as a data inserter module configured to insert special data into a modified version of a native file so as to make the modified file unreadable by an application that can read the native file from which the modified file is derived, a secure file creator configured to create a secure file based, at least in part, on the modified native file, the tracking information, and file access restrictions, a native file extractor configured to extract a native file from the secure file, and a tracker configured to access tracking information and/or to notify the distribution user when the secure file is accessed.

The encryption/decryption module 132 may include any system that may encrypt a file and decrypt an encrypted file. Further, the encryption/decryption module 132 may include any system that may render a native file 120 unreadable or inaccessible to an application 122 that created the native file 120 or may access the native file 120 before the encryption or obfuscation process. In some embodiments, the encryption/decryption module 132 may use a multi-level encryption process.

One example, non-limiting encryption process is as follows. The native file 120 to be encrypted may be read in to the computing system 102's RAM (not shown) byte by byte. The encryption/decryption module 132 may determine the placement of one or more special characters at one or more locations (including the header of the file) within the file based on a combination of the file's size, the date, and a random (or pseudo-random) number that may be based on, for example, a Globally Unique Identifier (GUIDE). An encrypted version of the file may then be read out of RAM with the special characters inserted at the identified placement points in the file. This encrypted version of the file is a copy of the native file 120 that is unreadable by the application that created the native file (e.g. The application 122). This encrypted unreadable copy of the native file may itself be encrypted. In some embodiments, this doubly encrypted file may be compressed and may further include a set of tracking options and a set of file access options that specify the access a recipient user is granted with respect to the copy of the native file included with the compressed encrypted file. The compressed encrypted file may then be distributed to authorized end users/receivers of the file.

The file distribution module 134 may include any system that may facilitate distributing the secure file 124 from one computing system to another computing system. Further, in some embodiments, the file distribution module 134 may prevent a recipient user (e.g. The user 114) from distributing the secure file 124 in response to the user 112 designating the file as non-transferable. In one embodiment, the file distribution module 134 may enable the secure file 124, or an edited copy of the secure file 124, to be transferred back to the user who provided the secure file 124, but may restrict distribution to any other users.

The tracking module 136 may include any system that may facilitate tracking access to and/or distribution of the secure file 124. Although not limited as such, access may include some or all operations that touch the secure file 124 and/or the copy of the native file 120 included in the secure file 124. For example, viewing, printing, copying, editing, moving, encrypting, decrypting, providing access to or distributing the secure file 124. In an embodiment, the recipient user is only able to receive the secure file 124 and do nothing more with the secure file 124 there forward. Further, the tracking module 136 may include tracking information with the secure file 124 to facilitate the tracking of receipt of, access to and other actions associated with the secure file 124. This tracking information may include, for example, one or more of the following: an identifier associated with the computing system 102 that created the native file 120, an identifier associated with the computing system 102 that created the secure file 124, an identifier associated with the computing system's 102 organization, an identifier associated with the user 112, an e-mail address associated with the user 112 or the organization associated with the computing system 102, an Internet Protocol (TIP) address, and a date and time, to name a few. In some embodiments, the tracking information is not accessible by the user 114. The secure file distribution system 140 or the secure file distribution client 150 may use the tracking information to facilitate reporting access of the secure file 124 to the computing system 102 and/or the user 112. In some embodiments, some or all of the tracking information may be stored at the tracking repository 160. Further, reports of access to the secure file 124 may be stored at the tracking repository 160.

The tracking repository 160 may include any repository system, including a database, that may be used to store tracking information to facilitate tracking access to the secure file 124. Further, the tracking repository 160 may be used to store a record of access to the secure file 124.

The file access module 138 may include any system that may control access to the secure file 124 in accordance with the set of user preferences provided by the user 112. Generally, these user preferences are provided during creation of the secure file 124. Although, in some embodiments, the user 112 may provide and/or modify the preferences prior to or at some time after the creation of the secure file 124. Further, the preferences may be specified in relation to the native file 120 that the user has selected to securely share.

As an example of controlling access to the secure file 124, the user 112 may specify that the secure file 124 may be viewed, but not modified or duplicated. In creating the secure file 124, the secure file distribution system 130 may include the file access restrictions with the encrypted version of the native file 120. Although the native file 120 is accessible by the application 122, the secure file 124 is not due to the encryption process, and in some embodiments, the insertion of special characters randomly or pseudo-randomly throughout the secure file 124. The user 112 may provide the secure file 124 to the user 114, with or without using the file distribution module 134.

Continuing the above example, the user 114 may access the secure file 124 using the secure file distribution system 140. The encryption/decryption module 132 may extract an encrypted version of the native file from the secure file 124 and decrypt the native file. Using the application 122, the file access module 138 of the secure file distribution system 140 may enable the user 114 to view the file. Further, the file access module 138 may prevent the user 114 from modifying the file or creating a copy of the file. In addition, if in creating the secure file 124 the user 112 opted to track access to the secure file 124, the tracking module 136 of the secure file distribution system 140 may alert the user 112 that the user 114 accessed the secure file 124, such as by sending the user 112 an email via the tracking module 136.

As a second example, suppose the user 112 specified that the secure file 124 may not be edited, but that a duplicate of the extracted native file 120 may be created. In this example, the file access module 138 may create the native file copy 126. This native file copy 126 may then be edited by accessing the native file copy 126 via the file access module 138, which in turn uses the application 122 to access the native file copy 126. Alternatively, in some embodiments, the user's 112 preferences are applicable to the secure file 124, but not the native file copy 126. Thus, once the native file copy 126 is created, the user 114 may access the native file copy 126 using application 122 directly without using the secure file distribution system 140.

The secure file 124 may be provided to the user 114 via, for example, the network 110, email, an FOP server, or any other distribution mechanism. In one embodiment, the secure file 124 is distributed via the file distribution module 134, which advantageously facilitates tracking of distribution of the secure file 124, particularly if the recipient of the secure file 124 distributes the file to one or more additional users.

To access the secure file 124, the user 114 may use the secure file distribution system 140. As illustrated in FIG. 1, the secure file distribution system 140 may include the same modules as the secure file distribution system 130. Further, in some embodiments, the secure file distribution system 140 may enable the user 114 to enforce a set of user preferences with respect to additional native files available to the user 114. Alternatively, to access the secure file 124, the user 116 may use a secure file distribution client 150. The secure file distribution client 150 may include a subset of the capabilities of the secure file distribution system 130. In some embodiments, the subset of capabilities enables the user 116 to access secure files provided by other users, but may or may not enable the creation of secure files for distribution to the other users.

In an embodiment, a file can be marked in such a way that data associated with the file is only intended for marking the file, such as with information regarding the file's origin, the distributing company, the distributing individual, the individual's email address, computer name, TIP address, etc., as well as a date and time stamp and other data. Once so marked, the data is inaccessible to any recipient. The marked data can also be inaccessible to the distributing user and only accessible by systems administration personnel or even a third party manager of the document control system.

Generally, the secure file distribution client 150 may include any system that may provide a user with access to a secure file 124 provided by the secure file distribution system 130 or 140. Further, the secure file distribution client 150 may include any system that may limit the access to the secure file 124 based on the user preferences specified by the user 112. Similar to the secure file distribution system 130, the secure file distribution client 150 may be implemented as hardware, software, or a combination of the two. Further, the secure file distribution client 150 may be hosted by computing devices (e.g. Computing system 106 or server 108) or may be a stand-alone device that may communicate with the computing devices.

In the depicted embodiment, the secure file distribution client 150 may include a decryption module 152, a tracking client 156, and a file access module 138. The decryption module 152 may include any system that may decrypt a secure file 124. The tracking client 156 may include any system that may report file access to a user 112 or record file access at the tracking repository 160. In some embodiments, the secure file distribution client 150 is a light version of the secure file distribution system 130 designed for file access, but not file distribution. Thus, the decryption module 152 may not include encryption capabilities in some embodiments. For similar reasons, in some embodiments, the tracking client 156 may provide tracking information as specified by the creator of the secure file 124, but may not enable the user 116 to specify tracking options if the user 116 redistributes the secure file 124, assuming the user 112 has granted the user 116 this capability.

In some embodiments, a secure file may be created from an existing secure file enabling a user to add additional file access restrictions or tracking options to those that were included with the existing secure file. For example, the user 112 may specify a set of file access restrictions and tracking options to be applied to the native file 120 when the secure file 124 is created. The user 114 may decide to distribute the secure file 124 to the user 116, but may want to add additional access restrictions and/or tracking options. The user 114 may create a second secure file (not shown) that includes the secure file 124 and the additional access restrictions and/or tracking options.

The users 112, 114, and 116 may generally represent an individual or an employee of an organization. Further, in some embodiments, the users 112, 114, and 116 may each represent one or more organizations.

An embodiment of a user interface for setting file distribution restrictions for one or more files is illustrated in FIG. 1A. When a distributing user elects to distribute one or more files in a secure manner to one or more end users, the distributing user may access an interface tool 170 that includes a number of sections. In the end user file tracking restrictions section 172, for one or more selected files, the distributing user may select radio boxes for various options including whether to enforce tracking, request email confirmation, and set password protection. Other options may also be included in section 172. If the enforce tracking option is checked, the system may automatically insert data, as discussed above into the file, such as in the header of a compressed version of the file, that causes the distributing user to be informed, via email or other communication methods, when the secured file has been accessed for the first time, even if the file has not been decrypted.

Before the file is decompressed to enable such access, the end user may be presented with an end user license agreement (ELLA) or other form of agreement, such as a subscription service, that seeks to secure the end user's cooperation prior to providing access. The agreement may include certain terms and conditions of use of the file, or use of the document access service, including permission to send email to or otherwise communicate with third parties regarding the end user's access to the file. Additional data that may be requested or collected at such time include the name of the end user, and company affiliation, a computer name, an TIP address, the name of the compression file, the data file name, date, time, etc., all of which may be transmitted back to the distribution user in some manner when the file is access for the first time. Additional data may also include payment information that enables the end user to access the file, such as a newspaper, technical document, book, multimedia application, game, music, movie, etc., once, a limited number of time, for a limited period of time, etc.

If the request email confirmation option is selected in section 172, the distribution user may be sent an email or other communication when the end user has un-encrypted the file and extracted any encrypted data. The password option enables the distribution user to set a password that the end user must use each time the file is opened.

In section 174, the end user file tracking restrictions may be set by the distribution user. The enforce tracking option, if checked, may cause data to be inserted into the file that informs the distributing user, via email or other communication means, that the file has been accessed, edited and/or transferred from the original end user. Such an option may be set to communicate such actions to the distribution user the first time each action occurs or every time such actions occur. Similarly, the request email confirmation option may be selected to enable the distribution user to be notified if the file is transferred to another for editing or other actions. The lockout “saves” option prevents the save as, clipboard, snapshot and other similar types of document or image capture operations from being used on the file. The file extension for the file is also altered so the file can only be recognized and displayed by the document control system. Any attempt by the end user to change the file extension would be worthless because the file is still encrypted. The lock layers options turns layers and similar types of functionality in certain types of documents, such as a drawing file or a text document, on and off.

In section 176, the distribution user may select each file to be secured and may identify when that secure file is going to be stored and what it will be called. In section 178, the distribution user may specify whether the secure file will be distributed by email, via a server and/or in a zip package, among other selections not shown. The distribution user may also specify whether any external reference files associated with the secure file will also be included with the secure file, and if so, whether those external files will be bound to the secure file or inserted into the host file. In section 178, the list of end users to which the secure file(s) will be distributed may be created. In section 180, if server distribution was selected in section 178, the distribution user can specify the server and location within the server from which the file can be accessed. In the event the file was moved in the future, the file may no longer be accessible unless returned to the specified location and server. Section 182 provides progress indicators to indicate packaging and email distribution progress, which may be necessary if large files are being processed or distributed so the distribution user does not get the impression that the distribution system is not working

### Example of a Secure File Creation Process

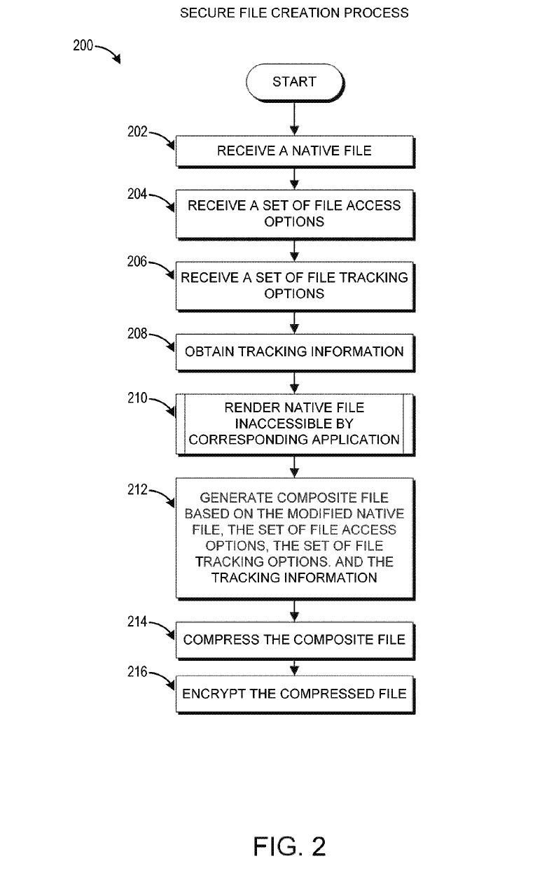

FIG. 2 illustrates a flow diagram for an embodiment of a secure file creation process 200. The process 200 may be implemented by any system that may create a secure file 124 from a native file 120. For example, the process 200, in whole or in part, may be implemented by the secure file distribution system 130, or one or more modules associated with the secure file distribution system 130.

The process 200 begins at block 202 where, for example, the secure file distribution system 130 receives a native file 120, or a copy of the native file 120. At block 204, the secure file distribution system 130 receives a set of file access options. The set of file access options may be received from the user 112, who desires to share the native file 120. Alternatively, the set of file access options may be received from an administrator associated with the same organization as the user 112. In some embodiments, the set of file access options may be obtained from a repository that may store one or more pre-defined sets of file access options for the user 112 or the user's 112 associated organization.

Generally, although not necessarily, the set of file access restrictions or options include a set of restrictions on actions that result in accessing (as defined below) the copy of the native file 120 to be included with the secure file 124. The set of file access options may include any file access privilege, operation, or restriction that may be applied to a file. Some non-limiting examples of the file access or restriction actions may include the following: viewing the file; editing, some or all, content in the file; printing the file; sharing file access with additional users; distributing the file to additional users; making copies of the file that may or may not include the same file access options; amending the file with additional content; and tracking or marking changes to the file (e.g. Via highlighting or changes in font or line color). Further, these file access actions may each be specified as privileges that enable a user to perform the operations or as restrictions that prevent a user from performing the operations. In some embodiments, the file access actions may be requirements that are enforced by the secure file distribution system 140 or the secure file distribution client 150. For example, if the user 112 specifies as part of the file access options that all changes to the file be marked for tracking purposes, then modifications to the copy of the file received by the user 114 will be marked. Further, the user 114 will be unable to make any modifications to the file copy of the file that are not marked. Advantageously, in some embodiments, the user 112, by using the secure file distribution system 130, may be assured that no modifications are made to a file provided to the user 114 or that any modifications are tracked for review or recreation purposes, for example.

At block 206, the secure file distribution system 130 receives a set of file tracking options, and at block 208, the secure file distribution system 130 obtains tracking information to facilitate implementation of the tracking options. Similar to the set of file access options, the set of file tracking options and the tracking information may be received from the distribution user 112 or an administrator, as described above with reference to FIG. 1A, or may be accessed from a repository (e.g. The tracking repository 160) that may store one or more predefined sets of file tracking options and tracking information.

The file tracking options may specify the file access operations to track and report when one of the specified file access operations is performed or requested. For example, the file tracking options may include a request to report the viewing, editing, decrypting, or distributing of the file to additional users. The file tracking options may or may not have a one-to-one correspondence with the file access options. Thus, in one example, a user 116 may be granted the ability to view or print the copy of the native file included with the secure file 124. However, in this example, the user 112 may have only requested to be notified when the file is viewed, but not when printed. Further, the information that is reported may include, for example, the file access operation performed, an identifier associated with computing system 104, an identifier associated with the user 114, an TIP address, the time of access, an identifier associated with the accessed file, and whether a ELLA was accepted.

The tracking information may specify any information necessary to track the secure file 124 and/or access to the secure file 124 or the copy of the native file included with the secure file 124. For example, the tracking information may include an e-mail address, a phone number (for voice or text purposes), an TIP address, a repository location (e.g. The location of tracking repository 160), a web address, or a unique identifier associated with a secure file distribution system 130, associated with the computing system 102, or associated with a specific organization. Further, the tracking information may include any information necessary to identity the file for reporting purposes. For example, the tracking information may include the file name, file version, file author, file owner, or a unique identifier associated with a specific copy of the secure file 124.

In one embodiment, one or more of blocks 204, 206, and 208 may be optional. For example, the user 112 may desire to track file access, but may not care to restrict the type of file access granted to the user 114. Alternatively, the user 112 may desire to restrict file access, but may not be interested in receiving tracking alerts.

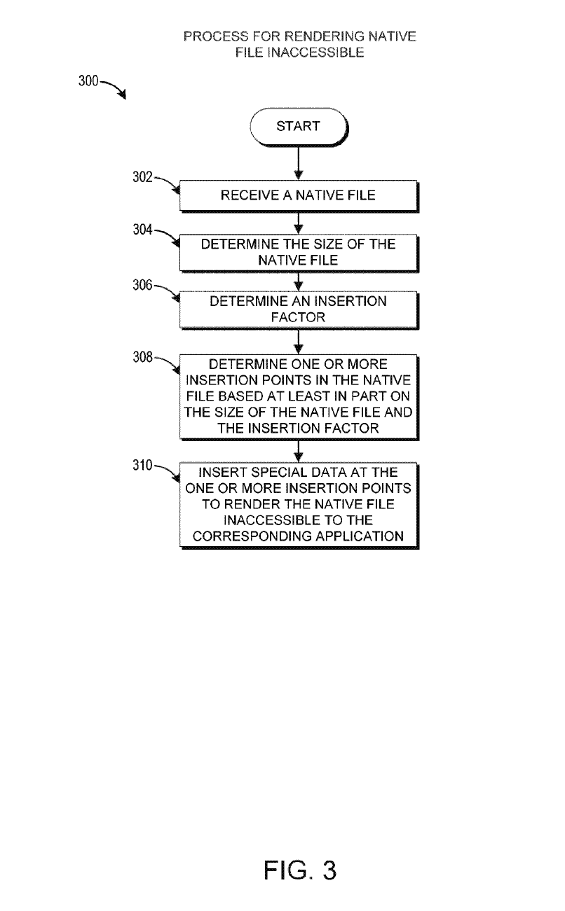

At block 210, the secure file distribution system 130 modifies a copy of the native file 120 to render the copy inaccessible by a corresponding application, such as application 122. The term “corresponding application” as used herein refers to applications that may create a native file or access a native file assuming the native file remains unchanged by the secure file distribution system 130. For example, if the native file is a pd., the corresponding application may include any pd. Viewer or pd. Generator, such as ADOBE ACROBAT®. The process of rendering the copy of the native file 120 inaccessible by the application 122 is further described below with reference to FIG. 3.

At block 212, the secure file distribution system 130 generates a composite file based, at least in part, on some or all of the following: the modified copy of the native file 120, the set of file access options, the set of file tracking options, and the tracking information. In some embodiments, the composite file may include a hash of some or all of the native file 120 and/or the modified copy of the native file 120. At block 214, the secure file distribution system 130 may compress the composite file. This may involve, for example, removing extraneous white space. Advantageously, in some embodiments, compressing the composite file may result in the size of the secure file 124 not exceeding or being equal to the size of the native file 120. In one embodiment, block 214 may be optional.

A simple exemplary file format for a secure file (including sample data) in XML is illustrated below:

<?xml version=“1.0”?>
<APDDSPackage xmlns:xsi=“http://www.w3.org/2001/XMLSchema-instance”
xmlns:xsd=“http://www.w3.org/2001/XMLSchema”>

<Author>Anthony Conte</Author>
<Address>25 Center St</Address>
<City>Madison</City>
<User>Optimus\Anthony</User>
<State>WI</State>
<Zip>53719</Zip>
<Timestamp>2011-06-01T08:34:02.2923188-05:00</Timestamp>
<IP>

192.168.10.3

</IP>
<Station>OPTIMUS</Station>
<APDDSFilename>C:\Users\Anthony\Desktop\test.dcss</APDDSFilename>
<Files>

<APDDSFile>

<Fileld>7cd83bfd-63af-4f0a-9034-c996c49293b0</Fileld>
<FileName>CRR-3A20-23-08-2007.dwg</FileName>

<CompressedFileBytes>H4siAAAAAAAEAOy9B2AcSZY1Ji9tynt/Sg==</Compressed

FileBytes>

<FileHashValue>63539872</FileHashValue>
<CompressedFileHashValue>54997947</CompressedFileHashValue>
<Timestamp>2011-06-01T08:35:02.2993192-05:00</Timestamp>

</APDDSFile>

</Files>
<Logs>

<APDDSFileLogEntry>

<Timestamp>0001-01-01T00:00:00</Timestamp>
<LogText>Sample Log Text</LogText>

</APDDSFileLogEntry>

</Logs>

</APDDSPackage>

At block 216, the secure file distribution system 130 encrypts the compressed file (or the composite file) to obtain the secure file 124. In some embodiments, the secure file 124 may include a hash of the compressed file and/or the composite file. The secure file distribution system 130 may use, for example, the encryption/decryption module 132 to facilitate encrypting the compressed file. Further, the secure file distribution system 130 may use any encryption algorithm to encrypt the compressed file. For example, the encryption algorithm may include: ACES, SHAD, RIDABLE, ROSA, DES or CAMELS, to name a few encryption algorithms.

In some embodiments, the secure file 124 may include data and/or a partial algorithm required to render the modified copy of the native file 120 accessible by the application 122. This data or partial algorithm may be included at any stage of the secure file creation process. For example, the data or partial algorithm may be included as part of the composite file generation process at block 212. In some embodiments, the algorithm or remainder of the algorithm required to render the modified copy of the native file 120 accessible by the application 122 may be included with the secure file distribution system 140 or the secure file distribution client 150.

In some embodiments, the process 200 may be used to create one or more secure files from multiple native files. For example, a number of CAD files associated with multiple rooms in a house may be combined into a single secure file created using the process 200. As a second example, a number of source code files that make up a single application may be combined into one or more secure files.

### Example of a Process for Rendering a Native File Inaccessible by a Corresponding Application

FIG. 3 illustrates a flow diagram for an embodiment of a process 300 for rendering a native file inaccessible by a corresponding application. The process 300 may be implemented by any system that may render a native file inaccessible by an application (e.g. The application 122) capable of accessing files of the same type as the native file. For example, the process 300, in whole or in part, may be implemented by the secure file distribution system 130, or one or more modules associated with the secure file distribution system 130. Further, some or all of the process 300 may be implemented as block 210 of the process 200.

The process 300 begins at block 302 where, for example, the secure file distribution system 130 receives a native file 120, or an unaltered copy of the native file 120. At block 304, the secure file distribution system 130 determines the size of the native file 120.

At block 306, the secure file distribution system 130 determines an insertion factor. This insertion factor may be based, at least in part, on a random number, or a pseudo-random number. Further, the insertion factor may be based, at least in part, on a date, a time, and/or a globally unique value, such as a globally unique identifier (GUIDE) value or a universally unique identifier (UUID) value.

At block 308, the secure file distribution system 130 determines one or more insertion points in the native file 120 based, at least in part, on the size of the native file and the insertion factor. The insertion points can be in the content of the native file, in a header of the native file or a combination of both. Block 308 may be performed after the native file is compressed, but prior to generation of the composite file, or prior to compression. The native file may also be compressed prior to block 308.

At block 310, the secure file distribution system 130 inserts special data at the one or more insertion points to render the native file inaccessible to the corresponding application (e.g. The application 122 that may have created the native file 120 or that may have previously been capable of accessing the native file 120 before the insertion of the special data). The exact nature of the special data may vary from application to application as the special data is intended to render the native file inaccessible to the application (or any application capable of reading such files) and the type of special data required to do so will depend on how the application itself works. The special data may be pre-defined by, for example, the user 112 or a manufacturer of the secure file distribution system 130. Further, the special data may be a single datum, or may include a set of data. In some embodiments, the special data may be selected randomly, or pseudo-randomly, from a set of available special data.

Advantageously, in certain embodiments, in addition to being dependent on the application 122, the special data may be dependent on the file type of the native file 120. For example, the special data may include one or more pieces of data from a first data set if the application 122 is of type X. However, if the application is of type Y, the special data may include one or more pieces of data from a second data set that differs from the first data set. In certain embodiments, selecting the special data based on the application 122 and/or the file type of the native file 120 facilitates ensuring that the native file is rendered inaccessible to the application 122 regardless of the type of application or file.

### Example of a Secure File Access Process

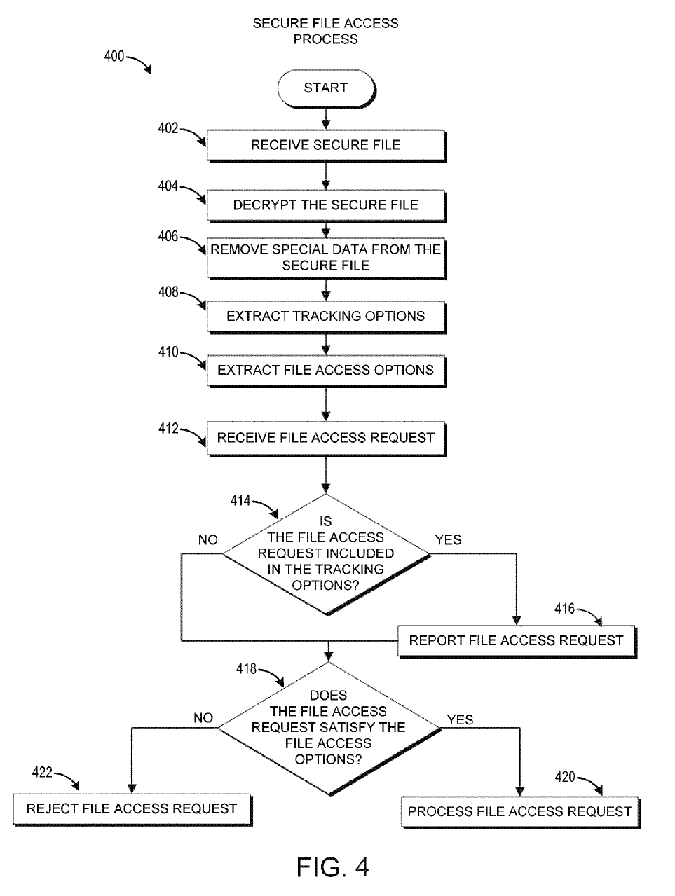

FIG. 4 illustrates a flow diagram for an embodiment of a secure file access process 400. The process 400 may be implemented by any system that may access a secure file 124, provide at least partial access to a copy of native file 120 included with the secure file 124, and provide tracking information related to the distribution and access of the secure file 124 to a user 112 who created the secure file 124 using the secure file distribution system 130. For example, the process 400, in whole or in part, may be implemented by the secure file distribution system 140 or the secure file distribution client 150 or the server 108. To simplify discussion, the process 400 will be described as being implemented by the secure file distribution system 140.

The process 400 begins at block 402 where, for example, the secure file distribution system 140 receives a secure file 124. This file may be received via the network 110, by accessing a server 108, from the computing system 102, from the secure file distribution system 130, from the file distribution module 134, or from a USB device, or from any other system or process that may be used to provide a file to the secure file distribution system 140.

At block 404, the secure file distribution system 140 using, for example, the encryption/decryption module 132 decrypts the secure file 124. In some embodiments, decrypting the file may include verifying a hash value associated with the secure file 124.

At block 406, the secure file distribution system 140 removes the special data previously inserted from the decrypted secure file 124. Removing the special data from the secure file 124 may include removing the special data from the copy of the native file 120 included with the secure file 124. In some embodiments, the secure file distribution system 140 may determine whether to remove the special data and how to remove the special data based on information included with the secure file 124. For example, the secure file 124 may identify the file type of the native file 120. This file type may be used to identify the type of data included with the copy of the native file 120 to render the copy of the native file inaccessible or unreadable by the application 122. In an embodiment, the identity of the file type of the native file and the instructions for removing the special data may not be included with the secure file 124. Hence, secure file distribution system 140 may have to access such data from another location which is either identified by the secure file 124, such as server 108, or some other location. In certain embodiments, block 406 may involve decompressing the decrypted secure file 124.

At block 408, the secure file distribution system 140 extracts tracking options from the secure file 124. Extracting the tracking options may include accessing tracking options associated with the secure file 124. In certain embodiments, block 408 may include presenting a ELLA to the user 114 relating to tracking access to the secure file 124 or the copy of the native file 120. If the user 114 does not accept the ELLA, the secure file distribution system 140 may cease performing the process 400. In some embodiments, block 408 may be optional.

At block 410, the secure file distribution system 140 extracts file access options from the secure file 124. Extracting the file access options from the secure file 124 may include accessing file access options associated with the secure file 124. In some embodiments, block 410 may be optional.

At block 412, the secure file distribution system 140 receives a secure file access request. The secure file access request may be received in response to any action by the user 114 or may be received in response to an operation performed by a computing system or application. As previously noted, an access request may include a broad range of possible actions, such as an attempt to open a file, read a file, edit a file, transfer a file, copy a file, save a file, save as a file, take a screenshot or extract an image or date from a file, print a file, attach a file to another file, etc.

At decision block 414, the secure file distribution system 140 determines if the file access request is included in the extracted tracking options. If so, or even if not, the secure file distribution system 140 may report the file access request at block 416, assuming reporting functions are implemented. Reporting the file access request may include alerting the user 112 (e.g. Via an e-mail or a text message) of the file access request or simply logging the access request at server 108 or some other location. Alternatively, or additionally, reporting the file access request may include recording the file access request at the tracking repository 160. Further, reporting the file access request may include reporting any information associated with the computing system 104, the user 114, or the file access request specified by the tracking options.

At decision block 418, the secure file distribution system 140 determines if the file access request satisfies the file access options. In some embodiments, determining if the file access request satisfies the file access options may include determining if the file access request is identified as an operation that has been restricted by, for example, the distribution user 112. Alternatively, or in addition, determining if the file access request satisfies the file access options may include determining if the file access request is identified as an operation or privilege that has been granted by the user 112.

If the file access request does satisfy the file access options, the secure file distribution system 140 processes the file access request at block 420. Processing the file access request may include performing the file access request, permitting the computing system 104 or an operating system associated with the computing system 104 to perform the file access request, or permitting the application 122 to perform the file access request. In some embodiments, to ensure that only permitted operations are performed, the secure file distribution system 140 executes the application 122 and maintains control over the application 122 thereby preventing the application 122 from performing any operations that have not been permitted by the user 112. For example, if editing the copy of the native file 120 is not permitted, the secure file distribution system 140 may either cause any editing options and/or any save options to be grayed out or may prevent the application 122 from performing any editing and/or save options selected by the user 114.

In one embodiment, processing the file access request includes making a working copy of the copy of the native file included with the secure file 124. The secure file distribution system 140 may perform the file access request with respect to the working copy. Advantageously, in certain embodiments, by performing the file access request with respect to the working copy, the user 112 and/or the user 114 may be assured that the original copy of the native file 120 included with the secure file 124 remains unmodified. In certain embodiments, the working copy may be accessed directly using the application 122. Alternatively, in certain embodiments, the working copy may only be accessed via the secure file distribution system 140, which may use the application 122 to facilitate access to and modification of the working copy.

If the file access request does not satisfy the file access options, the secure file distribution system 140 rejects the file access request at block 422. Depending on the tracking options, the secure file distribution client 140 may report the attempt to perform a restricted file access operation. Further, rejecting the file access request may include presenting the user 114 with a message or an alert reporting the rejected operation, which may include reporting the reason for the failed operation or file access request.

### Terminology

A number of computing systems have been described throughout this disclosure. The descriptions of these systems are not intended to limit the teachings or applicability of this disclosure. Further, the processing of the various components of the illustrated systems may be distributed across multiple machines, networks, and other computing resources. For example, each module of the secure file distribution system 130 may be implemented as separate devices or on separate computing systems, or alternatively as one device or one computing system. In addition, two or more components of a system may be combined into fewer components. Further, various components of the illustrated systems may be implemented in one or more virtual machines, rather than in dedicated computer hardware systems. Likewise, the data repositories shown may represent physical and/or logical data storage, including, for example, storage area networks or other distributed storage systems. Moreover, in some embodiments the connections between the components shown represent possible paths of data flow, rather than actual connections between hardware. While some examples of possible connections are shown, any of the subset of the components shown may communicate with any other subset of components in various implementations.

Depending on the embodiment, certain acts, events, or functions of any of the algorithms described herein may be performed in a different sequence, may be added, merged, or left out altogether (e.g., not all described acts or events are necessary for the practice of the algorithms). Moreover, in certain embodiments, acts or events may be performed concurrently, e.g., through multi-threaded processing, interrupt processing, or multiple processors or processor cores or on other parallel architectures, rather than sequentially.

Each of the various illustrated systems may be implemented as a computing system that is programmed or configured to perform the various functions described herein. The computing system may include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium. The various functions disclosed herein may be embodied in such program instructions, although some or all of the disclosed functions may alternatively be implemented in application-specific circuitry (e.g., ASICs or FPGAs) of the computer system. Where the computing system includes multiple computing devices, these devices may, but need not, be co-located. The results of the disclosed methods and tasks may be persistently stored by transforming physical storage devices, such as solid state memory chips and/or magnetic disks, into a different state. Each service described, such as those shown in FIG. 2, may be implemented by one or more computing devices, such as one or more physical servers programmed with associated server code.

Conditional language used herein, such as, among others, “may,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated may be made without departing from the spirit of the disclosure. As will be recognized, the processes described herein may be embodied within a form that does not provide all of the features and benefits set forth herein, as some features may be used or practiced separately from others. The scope of protection is defined by the appended claims rather than by the foregoing description. All changes which come within the meaning and range of equivalency of the claims are to be embraced within their scope.

What is claimed:

1. A system for facilitating file assurance, the system comprising:
a data inserter configured to insert data into a native file to create a modified native file, wherein an application associated with the native file may read the native file and is unable to read the modified native file;
a tracker configured to access tracking information associated with a secure file;
a file access module configured to associate one or more file access restrictions that restrict access to the secure file;
a secure file creator configured to create the secure file based, at least in part, on the modified native file, the tracking information, and the one or more file access restrictions; and
a file distributor configured to distribute the secure file to a computing system.

2. The system as recited in claim 1, wherein the data inserted into the native file to create a modified native file is based on the application.

3. The system as recited in claim 2, wherein the data inserted into the native file is based on a file type associated with the native file.

4. The system as recited in claim 1, wherein the data inserted into the native file to create a modified native file is based on a file type associated with the native file.

5. The system as recited in claim 1, wherein the data includes one or more special characters having one or more insertion points within the modified native file based on an insertion factor.

6. The system as recited in claim 5, wherein the insertion factor is based on one or more of a size of the native file, a date, a time, a random number and a pseudo-random number.

7. The system as recited in claim 5, wherein the insertion factor is based on a globally or universally unique identifier value.

8. The system as recited in claim 5, wherein the one or more insertion points are based on one or more of a size of the native file and the insertion factor.

9. The system as recited in claim 5, wherein the one or more insertion points are in content of the modified native file, a header of the modified native file or both the content of the modified native file and the header of the modified native file.

10. The system as recited in claim 1, further comprising a file compressor for compressing the native file prior to creation of the modified native file.

11. The system as recited in claim 1, further comprising a file compressor for compressing the modified native file.

12. A system for facilitating file assurance, the system comprising:
a file access control system configured to receive a secure file from a first user and to regulate a second user's access to the secure file, the file access control system comprising:
a native file extractor configured to extract a native file from the secure file;
a file access module configured to restrict the second user's access to the native file based on a set of file access restrictions associated with the secure file and to access the native file when authorized by the file access restrictions using an application associated with the native file; and
a tracker configured to provide an alert the first user in response to the second user accessing the secure file or the native file.

13. The system as recited in claim 12, wherein the file access restrictions include one or more file access actions of viewing, opening, editing, altering, moving, transferring, sharing, appending data to, printing, imaging, copying the native file.

14. The system as recited in claim 13, wherein the alerts are provided in response to at least one but not all of the one or more file access actions.

15. The system as recited in claim 14, further comprising a tracking repository for storing at least the file access restrictions, the file access actions, and the alerts.

16. The system as recited in claim 12, wherein the secure file includes a modified native file that includes one or more special characters inserted within the modified native file that render the modified native file unreadable by an application associated with the native file, and wherein the native file extractor is configured to remove the one or more special characters to extract the native file.

17. A method for facilitating file assurance, comprising the steps of:
receiving a native file;
receiving one or more file access restrictions;
receiving one or more tracking options;
creating an inaccessible native file by rendering the native file inaccessible to an application associated with the native file;
generating a composite file based on the inaccessible native file, the one or more tracking options, and the one or more file access restrictions; and
encrypting the composite file.

18. The method as recited in claim 17, further comprising the step of compressing the inaccessible native file prior to generating the composite file.

19. The method as recited in claim 17, further comprising the step of compressing the composite file prior to encrypting the composite file.

20. The method as recited in claim 17, wherein the step of creating an inaccessible native file includes the step of inserting data into the native file that results in the inaccessible native file being unreadable by the application.

21. The method as recited in claim 20, wherein the data inserted into the native file is based on the application.

22. The method as recited in claim 21, wherein the data inserted into the native file is based on a file type associated with the native file.

23. The method as recited in claim 20, wherein the data includes one or more special characters and wherein the one or more special characters are inserted at one or more insertion points based on an insertion factor.

24. The method as recited in claim 23, wherein the insertion factor is based on one or more of a size of the native file, a date, a time, a random number and a pseudo-random number.

25. The method as recited in claim 23, wherein the insertion factor is based on a globally or universally unique identifier value.

26. The method as recited in claim 23, wherein the one or more insertion points are based on one or more of a size of the native file and the insertion factor.

27. A method for facilitating file assurance, comprising the steps of:
receiving a secure file;
decrypting the secure file to create a composite file;
accessing a set of tracking restrictions associated with the composite file;
alerting a first user of access by a second user of the composite file based, at least in part, on the set of tracking restrictions;
receiving a file access command from the second user;
accessing a set of file access restrictions associated with the composite file;
determining if the file access command is permitted based on the set of file access restrictions;
rejecting the file access command if the file access command is not permitted; and extracting a modified native file from the secure file if the file access command is permitted, wherein the modified native file is based on a native file configured to be read by an application, and wherein the modified native file is unreadable by the application;
converting the modified native file to a readable native file capable of being read by the application; and
executing the file access command on the readable native file using the application.

28. The method as recited in claim 27, wherein the set of tracking restrictions are contained within the composite file.

29. The method as recited in claim 27, wherein the set of file access restrictions are contained within the composite file.

30. The method as recited in claim 27, wherein the step of accessing the set of tracking restrictions includes the step of obtaining the set of tracking restrictions from a server through a network connection.

31. The method as recited in claim 27, wherein the step of accessing the set of file access restrictions includes the step of obtaining the set of file access restrictions from a server through a network connection.

32. The method as recited in claim 27, wherein the step of converting the modified native file to the readable native file includes the step of removing data inserted into the native file, wherein the data inserted into the native file made the modified native file unreadable by the application.

33. The method as recited in claim 32, wherein the data inserted into the native file includes one or more special characters, and wherein the step of removing data includes the step of removing the one or more special characters from one or more insertion points in the native file.

34. The method as recited in claim 33, wherein the one or more insertion points are identified based on an insertion factor.

35. The method as recited in claim 34, wherein the insertion factor is contained in the composite file.

36. The method as recited in claim 34, wherein the insertion factor is obtained from a server through a network connection.

37. A method for facilitating file assurance, comprising the steps of:
receiving a secure file including a native file from a first user;
receiving an access request from a second user to access the secure file;
alerting the first user of the access request by the second user;
determining if the access request is permitted based on a set of file access restrictions associated with the secure file; and
if the file access command is permitted:
extracting a copy of the native file from the secure file without opening or modifying the native file with an application for accessing the native file; and
executing a file access command on the copy of the native file using the application.

38. The method as recited in claim 37, wherein the step of extracting a copy of the native file includes the steps of:
extracting a modified native file from the secure file, wherein the modified native file is unreadable by the application;
converting the modified native file to the copy of the native file by removing data inserted into the modified native file, wherein the data inserted into the modified native file made the modified native file unreadable by the application.

39. The method as recited in claim 38, wherein the data inserted into the native file includes one or more special characters, and wherein the step of removing data includes the step of removing the one or more special characters from one or more insertion points in the native file.

40. The method as recited in claim 39, wherein the one or more insertion points are identified based on an insertion factor.
